(19) United States
(12) Patent Application Publication
(10) Pub. No.: US 2019/0332706 A1
(43) Pub. Date: Oct. 31, 2019

(54) Systems and Methods for Providing Data Structure Access

(71) Applicant: MASTERCARD INTERNATIONAL INCORPORATED, PURCHASE, NY (US)

(72) Inventors: Rolando J. Leon, O'Fallon, MO (US); Shawn Mehrhoff, St. Ann, MO (US); Christopher T. Scholl, St. Peters, MO (US)

(21) Appl. No.: 15/964,281

(22) Filed: Apr. 27, 2018

(51) Int. Cl. G06F 17/30; G06Q 20/30; G06F 9/48

(52) U.S. Cl. CPC G06F 17/30471; G06F 9/48; G06Q 20/30

(57) ABSTRACT

Systems and methods are provided for providing data structure access. One exemplary system includes first and second data structures including first and second data, respectively, where at least some of the second data is disparate from the first data. First and second APIs are associated with the first and second data structures, respectively. And, an access engine computing device coupled to the first and second data structures is configured to receive a request, from a requestor, directed to the first and second data and call the first and second APIs to request the first and second data from the respective data structures. Upon receiving the first and second data, the computing device is configured to store the first and second data in memory and compile a data file including the data. The computing device is then configured to provide the data file to the requestor, in response to the request.

### FIELD

The present disclosure generally relates to systems and methods for providing access to multiple data structures and, in particular, to systems and methods for providing access to multiple data structures, whereby data associated with requests for access to the multiple data structures may be compiled and rendered in suitable formats.

### BACKGROUND

This section provides background information related to the present disclosure which is not necessarily prior art.

In a variety of different computing environments, data is known to be included in data structures where each of the data structures is associated with a source and/or a user. When a company, for example, is segregated into different business units, or subject matter divisions, or task-oriented groups, data, likewise, is often segregated among the different units, divisions, or groups. The data may be the same data, or different data, depending on underlying techniques used to gather the data or, potentially, on the use of the data by the company. It is further known to gather the data, from the different units, divisions, or groups, for example, to facilitate changes in how the company operates or interacts with customers.

### DRAWINGS

The drawings described herein are for illustrative purposes only of selected embodiments and not all possible implementations, and are not intended to limit the scope of the present disclosure.

FIG. 1 illustrates an exemplary system of the present disclosure suitable for use in accessing data from multiple disparate data structures;

FIG. 2 is a block diagram of a computing device that may be used in the exemplary system of FIG. 1; and

FIG. 3 is an exemplary method that may be implemented in connection with the system of FIG. 1 for use in accessing data from multiple disparate data structures.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

When data is segregated in multiple different data structures across an entity, such as, for example, a company, a business, etc., the data is often provided and/or arranged for the direct benefit of persons (or divisions) within the entity who collected and/or compiled the data (e.g., persons that may rely most directly on the data to perform various job duties for the entity, etc.). Occasionally, another person and/or division within the entity may require the data included in one or more of the data structures apart from the persons or divisions that collected and/or compiled the data, whereby the person and/or division may request that the data be provided or otherwise made available to the person and/or division. Since, as indicated above, the data may be segregated into the multiple disparate data structures across the entity, collection of the desired data from the different data structures may be cumbersome.

The systems and methods herein uniquely provide access to multiple different data structures, through an access engine, whereby requested data is returned from the multiple different data structures in a specified and/or requested format (e.g., as specified and/or requested by the access engine, as specified and/or requested to the access engine, etc.). In particular, the access engine is coupled in communication with the multiple different data structures. And, in response to a request for data, from a requestor, (internal or external to the entity associated with the data), the access engine facilitates an application programming interface (API) call to each of the multiple different data structures requesting the particular/desired data. In turn, each of the data structures provides the data requested in the API call back to the access engine. Upon receipt of the data, then, the access engine compiles the data (potentially, into a format indicated in the request) and delivers the data to the requestor (e.g., separately, merged together as appropriate, etc.). In this manner, the requestor avoids touching, contacting, etc. each data structure and/or users associated with each data structure, thereby providing a more efficient and more accurate data request process.

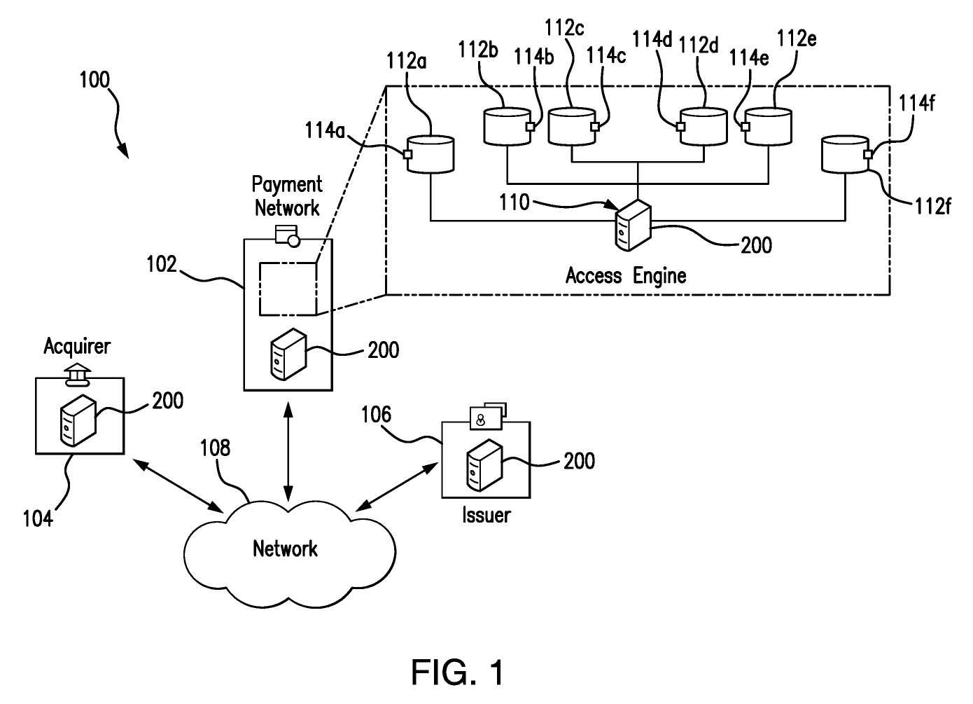

FIG. 1 illustrates an exemplary system 100 in which one or more aspects of the present disclosure may be implemented. Although the system 100 is presented in one arrangement, other embodiments may include the parts of the system 100 (or other parts) arranged otherwise depending on, for example, the number and types of entities included in the system, the type of data collected and/or stored in the system, etc.

The illustrated system 100 generally includes a payment network 102, an acquirer 104 generally associated with one or merchants, and an issuer 106 associated with one or more payment accounts provided to fund transactions at the one or more merchants. The payment network 102 is configured to, among other things, coordinate authorization, clearing, settlement, etc. of payment account transactions, initiated by consumers at the merchants, between the acquirer 104 and the issuer 106. In this exemplary embodiment, the acquirer 104 and the issuer 106 are banking institutions or other suitable entities. In connection therewith, the issuer 106 issues payment accounts (e.g., credit accounts, debit accounts, prepaid accounts, etc.) to the consumers who, in turn, may then purchase products at the merchants using the payment accounts (in the form of the payment account transactions). The payment network 102 then facilitates authorization of the payment account transactions at the issuer 106. And, the acquirer 104 is associated with the merchants, in that the acquirer 104 provides accounts for the merchants, with funds collected for the transactions (from the consumers and their accounts at the issuer 106) being appended to (or deposited into) the accounts of the appropriate merchants, through the clearing and settlement processes, by the payment network 102.

The payment network 102 may further be configured to provide other services to the acquirer 104 and/or the issuer 106, or potentially, even consumers. For example, the payment network 102 may be configured to provide enhanced authentication services, tokenization services, licensing services, virtual wallet service, billing services, fraud prevention services, bank identification number (BIN) assignments, card services, etc. With that said, it should be appreciated that the data described herein as collected and/or compiled by the payment network 102 is not limiting to the scope of the present disclosure.

As shown in FIG. 1, the payment network 102, the acquirer 104, and the issuer 106 are each coupled to (and are each in communication with) network 108. The network 108 may include, without limitation, a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof. For example, the network 108 may include multiple different networks, such as a private payment transaction network made accessible by the payment network 102 to the acquirer 104 and the issuer 106 and, separately, the public Internet, which may provide interconnection between the merchants and the acquirer 104 (as appropriate), etc.

In addition in the system 100, the payment network 102 is associated with (e.g., includes, is in communication with, etc.) an access engine 110 and multiple different data structures 112a-f coupled to (and/or in communication with) the access engine 110. As shown, the access engine 110 and the data structures 112a-f are illustrated as standalone parts of the payment network 102. As such, each may be considered a standalone computing device (e.g., where each of the access engine 110 and the data structures 112a-f may be included in one or more computing devices or in one or more common computing devices, etc.). Additionally, or alternatively, the access engine 110 and/or the data structures 112a-f may be integrated and/or incorporated, in whole or in part, with computing device 200 of the payment network 102 and/or with one or more other computing devices included in the payment network 102 in various embodiments, or more generally, in the system 100. Moreover, in still further embodiments, the access engine 110 may be integrated and/or incorporated, in whole or in part, with one or more of the data structures 112a-f.

Each of the data structures 112a-f is associated with and/or includes an API. As such, the illustrated data structures 112a-f include corresponding APIs 114a-f. The APIs 114a-f may be included in the same computing device(s) with the corresponding data structures 112a-f, as shown in FIG. 1, or may be separate therefrom in other system embodiments. In general, though, the APIs 114a-f include computer-executable instruction, which, when executed, configure the respective computing device (associated with the respective one or more of the data structures 112a-f) to permit access to and/or receive requests for data included in the multiple different data structures 112a-f, respectively, as describe in more detail below.

In this exemplary embodiment, the data structures 112a-f each include data associated with the payment network 102 and one or more services offered to customers by the payment network 102 and/or one or more services offered by the payment network 102 in general (be it to customers, employees, etc.). The data may be wholly different among the data structures 112a-f, or the data may overlap, in two or more of the data structures 112a-f. In this example, the data structure 112a includes debit transaction data, and the data structure 112b includes credit transaction data (similar to the debit transaction data). In connection therewith, the data structure 112a is associated with a debit transaction processing service, while the data structure 112b is associated with a credit transaction processing service. As such, transaction data from the debit transaction processing service is appended to the data structure 112a and transaction data from the credit transaction processing service is appended to the data structure 112b. The transaction data may be related to authorization, clearing and/or settlement of payment account transactions, and may include, for example, transaction identifiers, payment account numbers (e.g., primary account numbers (PANs, etc.), card identification numbers (CIDs), payment device expiration dates, merchant category codes, terminal identifiers, consumer names, merchant names, merchant contact information, acquirer identifiers, issuer identifiers, etc.

Also in this example, the data structure 112c includes various parameters that are being requested and that can only be produced by a specialized team (e.g., current billing setup, digital wallet reports, etc.). Such parameters are generally associated with a service offered by and/or provided by the payment network 102 (e.g., core products, digital payments, commercial products, etc.), for example, to different customers, etc. (e.g., acquirer 104, issuer 106, etc.). The data structure 112d includes data related to tokenization, such as, for example, tokens, payment account numbers, maps between tokens and payment account numbers, etc. In connection therewith, the data structure 112d is associated with the tokenization and/or digitization services of the payment network 102, through which consumers and issuers may manage tokens and/or digitized payment account data, etc. The data structure 112e is associated with franchise licensing services, whereby the data structure 112e includes, for example, identification of entities or institutions owning various different bank identification numbers (BINs) and identification of the BINs, brand products that are associated with the BINs, status of the BINs (e.g., active, reserved, transferring, recycled, etc.), information on the entities or institutions, etc. And, the data structure 112f is associated with management security services, and includes, for example, status of security certificates (e.g., created, being sent out, expired, etc.), registered security officers, types of certificates being exchanged, digital keys, etc.

It should be appreciated that the above data structures 112a-f, and the descriptions of data associated therewith, are provided for purposes of illustration and that other data structures and/or corresponding data, or more or less data structures and/or corresponding data, may be included in other embodiments, and more generally, in other system embodiments.

In operation, the access engine 110 is specifically configured (via instructions) to receive a request from a requestor, which may include the acquirer 104 and/or the issuer 106 (e.g., a customer of the payment network 102, etc.), or which may include a user internal to the payment network 102 (e.g., a company, a business unit, an employee, etc. of the payment network 102; etc.). For example, the access engine 110 (or the payment network 102) may be configured to cause an interface to be displayed to the requestor (at a computing device associated with the requestor) through which the requestor can generate the request. The access engine 110 may then receive a search query from the requestor, via the interface, for particular data, where the query includes one or more particular parameters for the desired data to be retrieved. The interface may allow for the requestor to specify desired products to which the data is related and to specify desired data. Or, the interface may include predefined options for products and data from which the requestor may choose. In any case, the request may generally relate to a product/service provided by the payment network 102 and utilized by the customer or other user.

In connection therewith, the request generally is specific to an identifier associated with the requestor, such as, for example, a user identifier (ID), a client ID or an Interbank Card Association (ICA) ID associated with a banking institution, etc., whereby the access engine 110 is configured to limit the search to data only accessible to the requestor (e.g., to data only for which the requestor has authorization to access, permission to access, etc.). In response to the request, the access engine 110 is configured to determine which of the APIs 114a-f to call, based on the data included in data structures 112a-f, the requested data associated with the request, and/or the requestor identifier. Once determined, the access engine 110 is configured to call the appropriate ones of the APIs 114a-f. The APIs 114a-f, when called, configure the computing devices in which the APIs 114a-f are included to retrieve the data requested, through the API calls, and to provide the retrieved data to the access engine 110. In turn, the access engine 110 is configured to receive and store the data in a temporary data structure therein, and then, to compile a data file for the received data, which may be in a generic format or which may be in a format specified by the requestor (e.g., in the request, etc.), whereby the access engine 110 is configured to convert the received data to the appropriate format as needed.

The access engine 110 is configured to then provide the data file to the requestor in response to the request. In this manner, the access engine 110 generally centralizes the compilation of data collection from the data structures 112a-f, such that the data requested by the requestor may be efficiently retrieved and provided to the requestor based on the single request, and without the requestor directing separate requests to each of the data structures 112a-f.

It should be appreciated that while only one acquirer 104 and one issuer 106 are included in the system 100, other system embodiments will generally include multiple of each of these parts in communication with the payment network 102, with interactions, as described above, by and between the parts. In addition, a different number of the data structures 112a-f and/or APIs 114a-f may be associated with the payment network 102. Moreover, while the description herein is presented with reference to the payment network 102 and the services provided thereby, the present disclosure may be employed with other types of entities, which include multiple disparate data structures, of substantial size, and/or that includes segregated data structures based on the use and/or data associated therewith, etc., and where data is often requested from multiple different ones of the data structures and combined for final use.

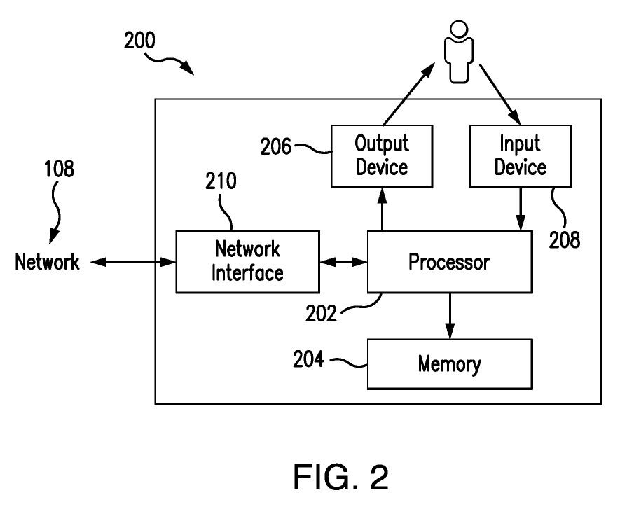

FIG. 2 illustrates an exemplary computing device 200 that can be used in the system 100. The computing device 200 may include, for example, one or more servers, workstations, personal computers, laptops, tablets, smartphones, PDAs, POS devices, etc. In addition, the computing device 200 may include a single computing device, or it may include multiple computing devices located in close proximity or distributed over a geographic region, so long as the computing devices are specifically configured to function as described herein. In the exemplary system 100 of FIG. 1, each of the payment network 102, the acquirer 104, and the issuer 106 are illustrated as including, or being implemented in, a computing device 200 (consistent with that illustrated in FIG. 2), coupled to (and in communication with) the network 108. In addition, the access engine 110 may include and/or may be implemented in a computing device consistent with computing device 200. Similarly, the data structures 112a-f and APIs 114a-f may each include and/or may each be implemented in a computing device consistent with the computing device 200. However, the system 100 should not be considered to be limited to the computing device 200, as described below, as different computing devices and/or arrangements of computing devices may be used. In addition, different components and/or arrangements of components may be used in other computing devices.

Referring to FIG. 2, the exemplary computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

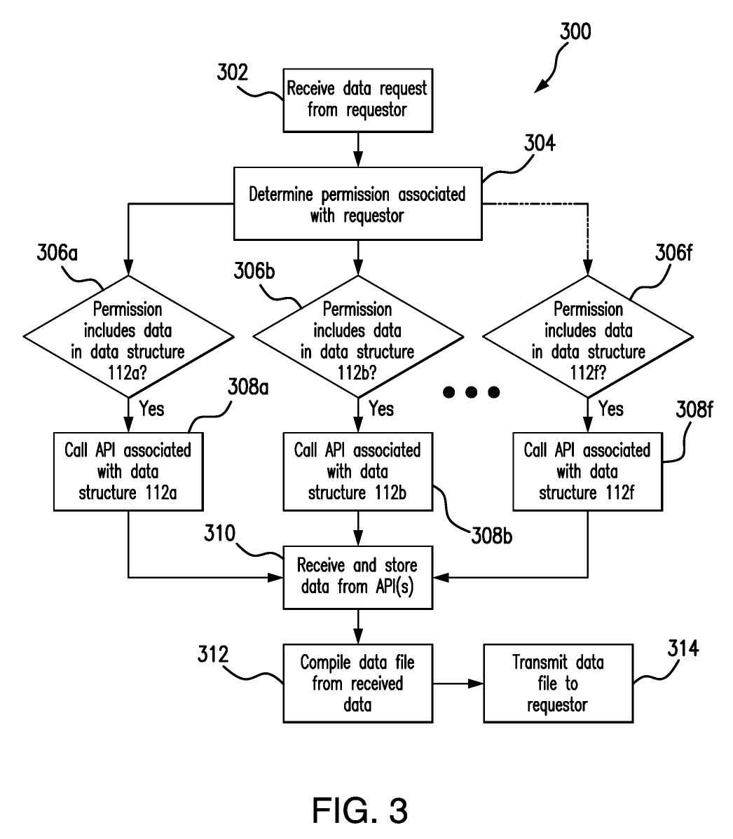

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. In connection therewith, the memory 204 may be configured, as one or more data structures (e.g., the data structures 112a-f, etc.), to store, without limitation, transaction data, and/or other types of data (and/or data structures) as described herein and/or as suitable for use as described herein. Furthermore, in various embodiments, computer-executable instructions may be stored in the memory 204 for execution by the processor 202 to cause the processor 202 to perform one or more of the operations described herein, such that the memory 204 is a physical, tangible, and non-transitory computer-readable storage media (e.g., such as specific computer-executable instructions consistent with the flow illustrated in FIG. 3 below, etc.). Such instructions often improve the efficiencies and/or performance of the processor 202 that is performing one or more of the various operations herein. It should be appreciated that the memory 204 may include a variety of different memories, each implemented in one or more of the functions or processes described herein.

In the exemplary embodiment, the computing device 200 includes an output device 206 that is coupled to (and is in communication with) the processor 202. The output device 206 outputs information (e.g., data files, request forms, request options, etc.), visually (e.g., in one of more interfaces, etc.), or audibly, for example, to a user of the computing device 200. The output device 206 may include, without limitation, a liquid crystal display (LCD), a light-emitting diode (LED) display, an organic LED (OLED) display, an “electronic ink” display, speakers, etc. In some embodiments, the output device 206 may include multiple devices. The computing device 200 also includes an input device 208 that receives inputs from the user (i.e., user inputs) such as, for example, entries of requestor identifiers, descriptions of requested data, format designations, etc. and/or that receives inputs from other computing devices (e.g., requested data from one or more of the data structures 112a-f, etc.). The input device 208 is coupled to (and is in communication with) the processor 202 and may include, for example, a keyboard, a pointing device, a mouse, a touch sensitive panel (e.g., a touch pad or a touch screen, etc.), another computing device, etc. Further, in various exemplary embodiments, a touch screen, such as that included in a tablet, a smartphone, or similar device, may behave as both the output device 206 and the input device 208.

In addition, the illustrated computing device 200 also includes a network interface 210 coupled to (and in communication with) the processor 202 and the memory 204. The network interface 210 may include, without limitation, a wired network adapter, a wireless network adapter, a mobile network adapter, or other device capable of communicating to one or more different networks, including the network 108. Further, in some exemplary embodiments, the computing device 200 may include the processor 202 and one or more network interfaces incorporated into or with the processor 202.

FIG. 3 illustrates an exemplary method 300 for providing access to multiple different data structures in connection with addressing a request for data included in one or more of the multiple different data structures. The exemplary method 300 is described with reference to the system 100 of FIG. 1 and as implemented in the access engine 110 of the payment network 102, the data structures 112a-f, and the APIs 114a-f, etc. Additional reference is also made to the computing device 200 of FIG. 2. However, it should be appreciated that the method 300 is not limited to the access engine 110, or more generally, to the system 100, or to the computing device 200. Likewise, the systems and computing devices herein should not be understood to be limited to the exemplary method 300.

At the outset in the method 300, a requestor associated with the payment network 102 determines that certain data in one or more of the data structures 112a-f is necessary and/or desired to perform one or more functions (e.g., either associated with the payment network 102, or not, etc.). As such, the requestor, in general, submits a request to the payment network 102 for the desired data. The request may be received from outside the payment network 102, such as, for example, where the requestor is a banking institution (e.g., the acquirer 104 or the issuer 106, etc.). Conversely, the request may be received from inside the payment network 102, such as, for example, where the requestor is an employee of the payment network 102. In either case, the requestor may, or may not, be associated with one or more services offered by payment network 102. However, in general, the data being requested by the requested may be associated with such one or more services.

In this exemplary embodiment, based on the above, the requestor submits a request to the access engine 110 for desired data (e.g., via the payment network 102, directly to the access engine 110, etc.). In turn, the access engine 110 receives the request, at 302. As discussed above, the request may include a variety of information, such as, for example, a data description for the requested data, either by services associated with the data, a specific identifier associated with the data, or otherwise. In addition, the request may include a requestor identifier for the requestor (e.g., an employee ID, a banking institution ID (e.g., an ICA, etc.), a user ID, etc.). When included, the requestor identifier may be used, by the access engine 110, to determine a permission for the requestor to utilize the access engine 110 as described herein and/or to access the particular data identified in the request (e.g., the access engine 110 may only access the data structures 112a-f when data at the data structures 112a-f is included in the permission, etc.) (broadly, authorize the requestor). For example, the access engine 110 may be configured to call the API 114a associated with the data structure 112a when data in the data structure 112a is included in the permission, but not call the API 114a when the data in the data structure 112a is not included in the permission. In addition, in connection with receiving the request (and potentially as part of determining such permission), the access engine 110 may request and/or require authentication of the requestor (also broadly, authorize the requestor) in conjunction with, or prior to, the requestor submitting the request, whereby data requests herein are limited to requestors with permission to submit requests (e.g., for requestors registered with the access engine 110, etc.) and/or with permission to submit requests for the specific data requested (e.g., for authenticated requestors, etc.).

In addition, the request received from the requestor may include, for example, a designated or specified format for the data to be received from the access engine 110. That is, various different formats of data may be included in the different data structures 112a-f, and/or the requestor may desire to receive data, and/or may require receipt of data, in a specific format different from any of the formats associated with the data in the data structures 112a-f. As such, the request may include the designated format, from the requestor, for use by the access engine 110 as described below. With that said, example data formats (e.g., for data stored in the data structures 112a-f, for data to be returned to the requestor, etc.) may include, without limitation, PDF, formats associated with EXCEL® spreadsheets, formats associated with WORD® documents, etc.

In connection with facilitating the request, the access engine 110 generally determines which of the data structures 112a-f includes data associated with the request. In connection therewith, the access engine 110 may utilize and/or generate for use one or more decision tables based on products associated with different requests and frequently requested reports associated therewith. As such, in generating the request, the requestor may be prompted to identify a predefined service to which the request is directed and then select one or more available, predefined data output options. Once the output option(s) is(are) selected, the access engine 110 may utilize the decision table to determine to which of the data structures 112a-f to make an API call for the desired data. For example, if a tokenization product is selected by the requestor, the access engine 110, via the decision table, may reduce the needed data structures to data structures 112b and 112d (dealing with credit transaction processing services and tokenization services), and prompt the requestor for desired parameters for the resulting output. Based on the parameters selected for the output, the API call may ping either the data structure 112b or the data structure 112d, or both, and retrieve the appropriate data. Table 1 includes an exemplary decision table (or data input table) that may be generated and/or used by the access engine 110, for example, to determine to which of the data structures 112a-f to make the API call for the desired data (e.g., CID data, ICA data, BIN data, product configuration data, etc.).

TABLE 1

| | Available Data Structures for Access | | | | | |
|---|---|---|---|---|---|---|
| Data Request | 112b | 112d | 112a | 112e | 112f | 112c |
| CID | X | X | X | X | X | X |
| ICA | X | X | X | X | | X |
| BIN | X | X | X | X | X | X |
| Product Configuration | X | X | | | | |

In another example, the requestor may include an employee user associated with the issuer 106. In connection therewith, the requestor may request, at 302, from the access engine 110, data indicative of a card image to be applied to an Apply Pay® wallet for a specific BIN. Such a request may be made when certain data is lost at the issuer 106 or when the original project manager is no longer associated with the issuer 106 and the desired data cannot be found. The data structures 112c, 112d, and 112e may then be needed, by the access engine 110, to analyze information at an institution level for the request, pull the configuration associated with the BIN, and produce the requested image file.

In a further example, the requestor may include an employee user associated with the acquirer 104. In connection therewith, the requestor may request, at 302, from the access engine 110, data indicative of a current setup for a BIN. For instance, a BIN may be transferring from one banking institution to another, and a project manager at the acquiring institution may desire to confirm the current setup. This request, therefore, provides a request for one or more icon(s) associated with the BIN and information associated with the BIN (e.g., contact information for the banking institutions, types of keys and certificates for the banking institutions, etc.). With that said, the data may be hierarchically structured with company ID/member ID at the top, filtering down to ICA(s), and BIN(s). And, the data structures 112c, 112e, and 112f may then be needed, by the access engine 110, to analyze information to provide the requested data.

With continued reference to FIG. 3, upon receipt of the request (and, potentially, upon determining which of the data structures 112a-f to access), the access engine 110 determines, at 304, a permission associated with the requestor providing the request (e.g., based on an identifier included in the request, etc.). Specifically, the access engine 110 may access a data structure of requestor identifiers comprising permissions for different requestor identifiers and indications of data for which the permissions are provided. For example, when the requestor identifier for the requestor includes an ICA, the data structure may include indications of data (and/or types thereof, etc.) associated with a banking institution for the ICA (and permissions therefore), such that permissions for data for other banking institutions are not provided. Similarly, when the requestor identifier for the requestor includes a company ID, the data structure may include indicators of data (and/or types thereof, etc.) associated with the particular company ID level. Moreover, when the requestor identifier indicates that the requestor is internal to the payment network 102, for example, the data structure may include indications that the requestor can access all available data (e.g., without restriction, etc.), or may again identify particular data for which access is available.

In any case, when a permission for the requestor is determined, the access engine 110 then determines if the permission includes data included in the available data structures 112a-f, or if the permission includes data included in the particular ones of the data structures identified by the access engine 110, such as, for example, one or more of the data structure 112a-f. Specifically in the method 300, the access engine 110 determines, at 306a, whether the permission of the requestor (as determined based on the requestor identifier, for example) extends to the data, in whole or in part, included in the first data structure 112a. If the permission does extend to the data structure 112a, the access engine 110 calls, at 308a, the API 114a (associated with the data structure 112a) in order to retrieve the requested data from the data structure 112a. The API call may include, for example, search criteria/key fields from the request (e.g., customer ID, BIN configuration, etc.), a request ID for the given request, a requestor ID, an indication of the requested data, etc.

However, if the permission does not extend to the data structure 112a, at 306a, for example, the access engine 110 does not call the API 114a associated with the data structure 112a. And, the access engine 110 moves on to a next one of the data structures 112b-f or halts until data is returned from one of more of the other data structures 112b-f. And, if no data is included in the permission (e.g., if the permission for the requestor does not extend to any of the available data structures 112a-f, etc.), or if there is no permission determined at all, the access engine 110 may, optionally, respond to the request, from the requestor, with an error and/or decline of the request.

After the call to the API 114a, at 308a, or in lieu thereof or currently therewith, the access engine 110 determines, at 306b, if the permission includes the data included in the data structure 112b. And, if the permission does extend to the data structure 112b, the access engine 110 calls, at 308b, the API 114b associated with the data structure 112b in order to retrieve the requested data from the data structure 112b. However, again, if the permission does not extend to the data structure 112b, the access engine 110 does not call the API 114b associated with the data structure 112b. As indicated by the ellipsis in FIG. 3, the access engine 110 continues to repeat steps 306 and 308 (sequentially or concurrently, etc.) until each of the data structures 112a-f, if implicated by and/or associated with the request, is either called, or not, based on the permission associated with the requestor.

As each of the API calls is made, the access engine 110 waits for data to be retrieved from the corresponding data structures 112a-f and returned, by the APIs 114a-f, to the access engine 110. As data is returned, the access engine 110 receives and stores the data, at 310, in memory (e.g., the memory 204, etc.). And, when all of the requested data is stored in the memory, the access engine 110 compiles, at 312, a data file in response to the request. In so doing, the access engine 110 may also (optionally) convert the data from a received format to a designated format specified by the requestor (e.g., in the given request, etc.) and compile the data file consistent with the designated format. Table 2 includes an exemplary output table that may be generated and/or used by the access engine 110, for example, to determine an available format for the data being output (e.g., in connection with the decision table of Table 1, etc.).

TABLE 2

Available Formats for Data Output

| Data Output | Excel | PDF | HTML | Word |
|---|---|---|---|---|
| Country and ICA | X | X | X | X |
| Wallet Provider | X | X | X | X |
| Authorization | X | X | X | X |
| Processing | | | | |
| Card Portfolio | X | X | X | X |
| Wallet Configuration | X | X | X | X |
| Product Configuration | X | X | X | X |
| Messages | X | X | X | X |
| Rules | X | X | X | X |
| Rule Sets | X | X | X | X |
| Card Range | X | X | X | X |
| White List Pan | X | X | X | X |
| Contacts and | X | X | X | X |
| Implementation | | | | |
| Information | | | | |

Finally in the method 300, once the data file is compiled, the access engine 110 transmits, at 314, the data file to the requestor, generally, in response to the request provided from the requestor. The data file may be transmitted, for example, via electronic mail (email), via an accessible web link, or otherwise, etc., potentially depending on the size of the data file and/or the preferences of the requestor, etc. In general, it should be appreciated that the access engine 110 stores the data on a temporary basis (e.g., at 310, etc.). As such, the access engine 110, in this exemplary embodiment, may subsequently purge and/or delete the data from the memory when the data file is provided to the requestor and/or at one or more defined intervals, etc. (e.g., as part of transmitting the data file to the requestor or shortly thereafter, within a defined period after transmitting the data file to the requestor, etc.).

In view of the above, the systems and methods herein provide a centralized access engine uniquely configured to access multiple data structures and retrieve desired data therefrom. In addition, the centralized access engine is uniquely configured to compile the retrieved data in one or more specified readable and modifiable formats (e.g., for presentation to requestors of the data, etc.). As such, the access engine may be used for consultation and/or download purposes of various parameters necessary by requestors to validate current system and/or service configurations or for service update purposes, etc.

Again and as previously described, it should be appreciated that the functions described herein, in some embodiments, may be described in computer executable instructions stored on a computer-readable media, and executable by one or more processors. The computer-readable media is a non-transitory computer-readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will also be appreciated based on the foregoing specification, the above-described embodiments of the disclosure may be implemented using computer programming or engineering techniques including computer software, firmware, hardware or any combination or subset thereof, wherein the technical effect may be achieved by: (a) receiving a request, from a requestor, for first data from a first data structure and second data from a second data structure, the first data structure different from the second data structure; (b) authorizing, by a computing device, the requestor in connection with the first and second data; (c) calling, by the computing device, an application programming interface (API) associated with the first data structure, when the requestor is authorized in connection with the first data, and receiving the first data from the first data structure; (d) calling, by the computing device, an API associated with the second data structure, when the requestor is authorized in connection with the second data, and receiving the second data from the second data structure; (e) storing, by the computing device, the received first and second data in memory coupled to the computing device; (f) compiling, by the computing device, a data file including the first and second data; (g) transmitting, by the computing device, the data file to the requestor, in response to the request, thereby providing data from the first and second data structures to the requestor based on the single request received from the requestor and without the requestor directing separate requests to each of the first and second data structures; (h) deleting, from the memory, the first data and the second data stored in the memory within a defined period after transmitting the data file to the requestor; (i) converting, by the computing device, a format of the received first data and/or a format of the received second data to a designated data format, when the format of the received first data and/or the format of the received second data is different from the designated data format; (j) not calling the API associated with the first data structure when the requestor is not authorized in connection with the first data; and (k) not calling the API associated with the second data structure when the requestor is not authorized in connection with the second data.

Exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A system for use in providing access to multiple different data structures, the system comprising:
a first data structure including first data;
a second data structure including second data, at least some of the second data disparate from at least some of the first data included in the first data structure;
a first application programming interface (API) associated with the first data structure;
a second API associated with the second data structure; and
an access engine computing device coupled to the first data structure and the second data structure, the access engine computing device configured, by executable instructions, to:
receive a request from a requestor, the request directed to the first data and the second data;
call the first API to request the first data from the first data structure;
call the second API to request the second data from the second data structure;
receive the first data from the first data structure, via the first API;
receive the second data from the second data structure, via the second API;
store the received first and second data in memory coupled to the access engine computing device;
compile a data file including the first and second data; and
transmit the data file to the requestor, in response to the request, thereby providing data from the first and second data structures to the requestor based on the single request received from the requestor and without the requestor directing separate requests to each of the first and second data structures.

2. The system of claim 1, wherein the request is specific to a service associated with a payment network, the service reliant on the first data and the second data.

3. The system of claim 2, further comprising the payment network, the payment network comprising the access computing device.

4. The system of claim 1, wherein the request includes a requestor identifier; and
wherein the access engine computing device is configured, by the executable instructions, to determine a permission for the requestor in association with the first and second data, based on the requestor identifier, and to call the first API only when the first data is included in the permission.

5. The system of claim 4, further comprising a third data structure coupled to the access engine computing device, the third data structure including third data different than at least some of the second data; and
wherein the access engine computing device is configured, by the executable instructions, to call a third API associated with the third data structure when the third data is included in the permission, but not call the third API when the third data is excluded from the permission.

6. The system of claim 1, wherein the first data includes one of debit transaction data and credit transaction data; and
wherein the second data includes one or more of token data for payment accounts, payment account number data for the payment accounts, and map data mapping the token data and the payment account number data.

7. The system of claim 1, further comprising a third data structure coupled to the access engine computing device, the third data structure including third data different than at least some of the second data; and
wherein the access engine computing device is configured, by the executable instructions, to:
call a third API associated with the third data structure;
receive and store the third data from the third data structure in the memory; and
compile the third data into the data file, prior to transmitting the data file to the requestor.

8. The system of claim 7, further comprising a first computing device including the first data structure, a second computing device including the second data structure, and a third computing device including the third data structure; and
wherein at least the first computing device is different than the third computing device.

9. The system of claim 8, wherein the access engine computing device includes at least one of the first computing device, the second computing device, and the third computing device.

10. The system of claim 1, wherein the request includes a designated format for the first and second data; and
wherein the access engine computing device is configured, by the executable instructions, to compile the data file consistent with the designated format.

11. The system of claim 10, wherein the access engine computing device is configured, by the executable instructions, to convert a format of the received first data and/or a format of the received second data to the designated format, when the format of the received first data and/or the format of the received second data is different from the designated format.

12. The system of claim 1, further comprising a payment network including the access engine computing device; and
wherein the requestor includes a banking institution.

13. The system of claim 1, wherein the access engine computing device is further configured to purge, from the memory, the first data and the second data stored in the memory within a defined period after transmitting the data file to the requestor.

14. A computer-implemented method for providing access to multiple different data structures, the method comprising:
receiving a request, from a requestor, for first data from a first data structure and second data from a second data structure, the first data structure different from the second data structure;
authorizing, by a computing device, the requestor in connection with the first and second data;
calling, by the computing device, an application programming interface (API) associated with the first data structure, when the requestor is authorized in connection with the first data, and receiving the first data from the first data structure;
calling, by the computing device, an API associated with the second data structure, when the requestor is authorized in connection with the second data, and receiving the second data from the second data structure;
storing, by the computing device, the received first and second data in memory coupled to the computing device;
compiling, by the computing device, a data file including the first and second data; and
transmitting, by the computing device, the data file to the requestor, in response to the request, thereby providing data from the first and second data structures to the requestor based on the single request received from the requestor and without the requestor directing separate requests to each of the first and second data structures.

15. The computer-implemented method of claim 14, wherein authorizing the requestor includes determining a permission for the requestor to access the first and second data, based on a requestor identifier for the requestor included in the request.

16. The computer-implemented method of claim 15, wherein authorizing the requestor further includes authenticating the user to the computing device.

17. The computer-implemented method of claim 14, further comprising deleting, from the memory, the first data and the second data stored in the memory within a defined period after transmitting the data file to the requestor.

18. The computer-implemented method of claim 14, wherein compiling the data file includes compiling the data file consistent with a designated data format included in the request for the first and second data.

19. The computer-implemented method of claim 18, further comprising converting, by the computing device, a format of the received first data and/or a format of the received second data to the designated data format, when the format of the received first data and/or the format of the received second data is different from the designated data format.

20. The computer-implemented method of claim 14, further comprising:
not calling the API associated with the first data structure when the requestor is not authorized in connection with the first data; and
not calling the API associated with the second data structure when the requestor is not authorized in connection with the second data.
